(19) United States
(12) Patent Application Publication
(10) Pub. No.: US 2007/0173151 A1
(43) Pub. Date: Jul. 26, 2007

(54) Semiconducting winding strip and use thereof

(75) Inventors: Heinrich Kapitza, Furth (DE); Volker Muhrer, Furth (DE); Norbert Muller, Pretzfeld (DE)

Correspondence Address: YOUNG & THOMPSON, 745 SOUTH 23RD STREET, 2ND FLOOR, ARLINGTON, VA, 22202, US

(73) Assignee: SIEMENS AKTIENGESELLSCHART, Munchen (DE)

(21) Appl. No.: 10/587,696

(22) PCT Filed: Feb. 3, 2005
(86) PCT No.: PCT/EP05/50467

§ 371 Date: Jul. 27, 2006

(30) Foreign Application Priority Data
Feb. 4, 2004 (DE) 10 2004 005 548.3

(51) Int. Cl. B32B 27/04; B32B 7/12; B32B 5/02

(52) U.S. Cl. 442/149; 428/343

(57) ABSTRACT

The invention relates to a semiconducting winding strip which is suitable for equipotential bonding in high-voltage transformers. The filling material is selected in such a way that a semiconducting strip is obtained by saturation concentration in a binding agent, enabling good reproducible strips to be obtained, particularly with respect to the specific resistance thereof.

The invention relates to a semiconducting tape, specifically one that is suitable for equipotential bonding in high voltage transformers.

In high voltage transformers, the yokes consisting of individual plates stacked one on top of the other are bandaged with insulating tape also known as wrapping tape. During operation a potential drop is produced between the electrically conducting yoke and the insulating tape. The maximum value of the electrical voltage is determined by the corresponding breakdown field strength of air. If this is exceeded, corona and surface discharges occur which may destroy the insulation. It is attempted to avoid this by first mounting a semiconducting intermediate layer in the form of wrapping tape as equipotential bonding on the yoke prior to bandaging with the insulating tape.

Known tapes are made of epoxy resin, preferably a carbon black filled epoxy resin which only cures at elevated temperature. Glass fabric tapes are impregnated with said epoxy resin and the tapes are produced therefrom.

The electrical resistance of these tapes is set via the amount of incorporated carbon black. The problem, however, is that in the area of interest for this application a small addition or release of carbon black changes the conductivity/resistivity of the tape by several powers of ten, thereby significantly impacting manufacturing reliability. The desired conductivity is in the range 10³ to 10⁶ Ωcm which is obtained at approx. 21.5-23% carbon black content in the epoxy resin. Between 15% and 25% carbon black content, the resistivity of the resulting epoxy resin falls from 10¹⁴ Ωcm to 10¹ Ωcm, so that there are major problems in terms of the reproducibility of the set and desired conductivity.

The object of the present invention is therefore to provide a material for a semiconducting tape for use as wrapping tape that meets the mechanical requirements for use on a high voltage transformer, while at the same time having a readily reproducible surface resistivity in the range 1-100 kohm/square and a low variance of electrical characteristics along the tape.

The inventive achievement of this object for which protection is sought is set forth in the independent and dependent claims as well as the description and the examples contained therein.

The subject matter of the invention is a tape made of a fabric material impregnated with a filler-containing binder, the filler in the overpercolated state producing a surface resistivity in the range 1-100 kohm/square in the binder. The subject matter of the invention is also a use of the tape as wrapping tape in electrical machines, particularly high voltage machines, transformers, chokes and for equipotential bonding in high voltage transformers.

The filler is therefore selected such that the concentration in the overpercolated state in the fabric-reinforced plastic matrix corresponds to a resistivity in the range 1-100 kohm/square. The means that the addition of filler can even vary within certain acceptable limits for mass production and in respect of reproducibility without the resistivity value leaving the desired and defined range.

Overpercolated means here that when further filler is added no significant change in the resistive behavior occurs, as so many contacts between the conductive particles already exist that any additional increase in the concentration has little further effect on the resistivity.

The filler is advantageously coated with a layer of antimony-tin mixed oxide, specifically with an antimony doped tin oxide layer. Its conductivity level can be set by means of the antimony portion in the mixed oxide, the coating thickness of the mixed oxide and the particle size and shape of the fillers. Antimony-tin oxide fillers can also be used.

In particular, overlays and/or coatings are selected whose thickness is in the region of one nm to a few hundred μm, most preferably in the range 5 nm to 20 μm, or 50 nm to 7 μm, etc.

All well-known inorganic and/or mineral fillers can be used, such a potassium titanate, Al₂O₃ (corundum), chalk, talc, barium sulfate, SiO₂ (quartz), fused silica flour, kaolin, titanium dioxide, titanates generally, mica and similar. Also possible are fillers which, prior to overlaying with antimony-tin oxide, are coated with another layer, e.g. SiO₂.

The filler is preferably added in a quantity of 20 to 50 wt %, most preferably 22 to 45 wt %, referred to the solids content in the binder.

The ratio of antimony to tin in the mixed oxide can vary within wide limits, the proportion of antimony generally being less than that of tin, i.e. antimony oxide <50% and tin oxide >50% in the mixed oxide. Preferably the proportion of antimony is 30% or less and the proportion of tin 70% or more.

The particle size of the filler is preferably in the range <15 μm (average particle size). The filler particle shape is preferably angular and/or platy and/or whisker-shaped.

However, according to the invention the coated filler and the coating can be selected as required.

The antimony doped tin oxide layer is advantageously applied to the filler either by coating the fillers with an organic antimony-tin compound which is then thermally calcined or by placing a hydrolyzed antimony and tin compound in an aqueous filler dispersion. The fillers coated in this way are commercially available.

Both glass fabrics and organic fiber fabrics are possible as fabric material. Organic fabrics made of aramid fibers and/or polyester fibers are generally used. In so far as they are compatible with the requirements for insulating materials for e.g. high voltage transformers, other organic fabric types e.g. based on propylene and/or fluorized polymers can also be used. In order to minimize the coating on the winding e.g. when using the tape as wrapping tape, fabric types with a basis weight of 30 to 1000 g/m² are generally used.

Possible binders include in principle a wide variety of reactive resins, such as alkyd resins, polyester resins, silicone resins and imide resins. However, although epoxy resins have proved their worth because of their balanced characteristics profile in respect of dielectric properties, temperature stability and processing behavior as well as good compatibility with the insulating system, aromatic lucidly ethers have become particularly established. Amine compounds are preferably used as curing agents and/or accelerators for tapes. For problem-free processing, a certain flexibility of the not yet cured tapes is necessary in order enable them to be wrapped on the substrate without creasing or pocket formation. Slight self-adhesion is also advantageous in order to be able to work without additional fixing with adhesive tapes.

The semiconducting tapes according to the invention are proauced by the normal methods for producing insulating tapes, using binder solutions in which the semiconducting filler is dispersed. The viscosity and therefore the deposit on the fabric material is determined by the concentration of the binder and of the filler in the solution. The fabric materials are either drawn through and/or sprayed with the solution as tapes of different widths. The tape is then passed through a horizontal or vertical drying section at elevated temperature and/or in the gas flow in order to remove the solvent. The tape is then reeled up.

The inventive semiconducting tapes described here can be used as equipotential bonding in the manufacture of high voltage transformers. However, they can likewise also be used in electrical machines generally, particularly high voltage machines, transformers and chokes if semiconducting layers with a defined surface resistivity in the range between 1 and 100 kΩ/square are to be used for equipotential bonding.

The invention will now be explained with reference to a number of examples:

General Specification for Tape Fabrication

To impregnate the tape, a fabric tape as substrate material is drawn at defined speed through a container filled with the impregnating resin. The resin stock is continuously stirred before and during the test practice in order to prevent the settling of the conductive filler. After impregnation, the corona shield tape is fed through a drying tower with 4 heating zones adjustable independently of one another. In the examples quoted, the following drying conditions are employed: δ₁=90° C., δ₂=140° C., δ₃=110° C., δ₄=70° C., tape speed: 20 cm/min.

### EXAMPLES 1-6

In examples 1-6, antimony-tin oxide coated micas were used. The composition of the binders is summarized in Table 2. By way of explanation, the meaning of the symbols is given in Table 1. A glass fabric tape (width 50 mm, thickness 0.2 mm, basis weight approximately 200 g/m²) was used the fabric material. Production took place analogously to the above described specification. Noticeable is the effect of the filler content on the resistivity of the tapes (examples 1-5), and the reproducibility of the results (example 1,6). The values in brackets indicate the test results at various locations on the tape and show the low variance.

TABLE 1

| Component | Abbrev. |
|---|---|
| Epoxy novolac | EP 1 |
| EP value: 5.56 mol/kg; viscosity at | |
| 80° C.: 1500 mPas | |
| Ethylmethylketone | MEK |
| Dimethylformamide | DMF |
| Dicyandiamide | DICY |
| 2-Methylimidazole | 2 MI |
| with antimony doped tin oxide coated mica | F1 |
| Thickness: 3.6 g/cm3, particle size < 15 μm | |
| (laser diffraction), mass ratio | |
| mica/mixed oxide: approx. 1:1 | |
| Mass ratio Sb/Sn: 15/85 | |

TABLE 2

| | EP 1 | MEK | DMF | 2-MI | DICY | F 1 | Filler | Resistivity |
|---|---|---|---|---|---|---|---|---|
| Example | MT | MT | MT | MT | MT | MT | as %¹⁾ | kohm/square |
| 1 | 100 | 30 | 20 | 0.1 | 5 | 50 | 32.3 | 17.5 |
| | | | | | | | | (16.1; 18.8; 17.2; 18.1; |
| | | | | | | | | 17.3) |
| 2 | 100 | 35 | 20 | 0.1 | 6 | 55 | 34.2 | 8.7 (7.5; 8.3; 9.4; |
| | | | | | | | | 9.6; 8.7) |
| 3 | 100 | 50 | 20 | 0.1 | 5 | 75 | 41.7 | 1.2 (1.0; 1.2; 1.2 |
| | | | | | | | | 1.3; 1.3) |
| 4 | 100 | 30 | 20 | 0.1 | 5 | 30 | 22.2 | 90.5 (87.3; 91.0; |
| | | | | | | | | 93.6; 89.5 91.1) |
| 5 | 100 | 30 | 20 | 0.1 | 5 | 45 | 30.0 | 50.1 (47.5; 49.6; |
| | | | | | | | | 51.1; 52.5; 49.8) |
| 6 | 100 | 30 | 20 | 0.1 | 5 | 50 | 32.3 | 15.5 (16.1; 14.3; |
| | | | | | | | | 14.8; 15.1; 17.2) |

¹⁾wt % referred to solids in the binder

The resistivity of the tapes is measured on a 50 mm wide tape a length of 50 mm

The test pieces (5 per formulation) are each provided with two conductive silver electrodes 10 mm wide and 50 mm long applied parallel to one another 50 mm apart. The conductive silver electrodes are contacted by means of crocodile clips and the relevant surface resistivity is measured using a multimeter (measurement voltage<10V).

Prior to testing, the tapes are cured for five hours at 130° C. in a laboratory furnace.

As the repetition of example 1 as example 6 shows, satisfactory reproducibility of the electrical tape properties can be assumed. Likewise only slight variance of the electrical tape properties along the tape is apparent.

1. A tape made of fabric material which is impregnated with a filler-containing binder, the filler producing a surface resistivity in the range 1-100 kohm/square in the overpercolated state in the binder.

2. The tape as claimed in claim 1, wherein the filler is coated with a layer of antimony-tin mixed oxide.

3. The tape as claimed in claim 1, wherein the thickness of the coating of filler ranges from one nm to a few hundred μm.

4. The tape as claimed in claim 1, wherein the filler is selected from the following group: potassium titanate, Al₂O₃ (corundum), chalk, talc, barium sulfate, SiO₂ (quartz), fused silica flour, kaolin, titanium dioxide, titanates and/or micas.

5. A use of the tape as claimed claim 1 in electrical machines, high voltage machines, transformers, chokes and/or for equipotential bonding in high voltage transformers.

6. The tape as claimed in claim 2, wherein the thickness of the coating of filler ranges from one nm to a few hundred μm.

7. The tape as claimed in claim 2, wherein the filler is selected from the following group: potassium titanate, Al₂O₃ (corundum), chalk, talc, barium sulfate, SiO₂ (quartz), fused silica flour, kaolin, titanium dioxide, titanates and/or micas.

8. The tape as claimed in claim 3, wherein the filler is selected from the following group: potassium titanate, Al₂O₃ (corundum) , chalk, talc, barium sulfate, SiO₂ (quartz), fused silica flour, kaolin, titanium dioxide, titanates and/or micas.
